(19) United States
(12) Patent Application Publication
(10) Pub. No.: US 2025/0200446 A1
(43) Pub. Date: Jun. 19, 2025

(54) SELF-ADJUSTING MULTI-SENSOR SYSTEM BASED ON MACHINE LEARNING

(71) Applicant: International Business Machines Corporation, Armonk, NY (US)

(72) Inventors: Patrick Ruch, Pratval (CH); Gianmarco Gabrieli, Zurich (CH); Michal Muszynski, Adliswil (CH); Keiji Matsumoto, Yokohama (JP)

(21) Appl. No.: 18/545,125

(22) Filed: Dec. 19, 2023

(51) Int. Cl. G06N 20/20

(52) U.S. Cl. CPC G06N 20/20

(57) ABSTRACT

In an approach for performing a self-adjustment of a multi-sensor data processing environment, a processor trains a first set of machine learning models on a first combination of a first set of data features. A processor measures a sub-set of a set of training samples to provide a second set of data features. A processor combines the first set of data features and the second set of data features to obtain a third set of data features, wherein the third set of data features is a preferred set of data features. A processor recommends, for use by a multi-sensor system, a first machine learning model employing the preferred set of data features.

### BACKGROUND OF THE INVENTION

The present invention relates generally to computer systems, and more specifically, to a self-adjusting multi-sensor system based on machine learning.

A multi-sensor system is a system comprised of two or more sensors responsible for collecting a set of data about a product and/or a process being tested over a period of time.

A multi-sensor system employing Artificial Intelligence (AI), more specifically a machine learning technique, is becoming more prevalent and more widely used. A reason why the multi-sensor system employing AI is becoming more prevalent and more widely used is because the multi-sensor system can perform more complex measurements and/or can provide an analysis of the product and/or process being tested and of the measurements performed.

Machine learning is a branch of AI and computer science which focuses on the use of data and algorithms to imitate the way that humans learn, gradually improving its accuracy. In general, a machine learning algorithm is used to make a prediction or classification. Based on some input data, which can be labeled or unlabeled, the machine learning algorithm will produce an estimate about a pattern in the data. An error function evaluates the prediction of the model. If there are known examples, an error function can make a comparison to assess the accuracy of the model. If the model can fit better to the data points in the training set, then weights are adjusted to reduce the discrepancy between the known example and the model estimate. The machine learning algorithm will repeat this “evaluate and optimize” process, updating weights autonomously until a threshold of accuracy has been met.

### SUMMARY

Aspects of an embodiment of the present invention disclose a method, computer program product, and computer system for performing a self-adjustment of a multi-sensor data processing environment. A processor trains a first set of machine learning models on a first combination of a first set of data features. A processor measures a sub-set of a set of training samples to provide a second set of data features. A processor combines the first set of data features and the second set of data features to obtain a third set of data features, wherein the third set of data features is a preferred set of data features. A processor recommends, for use by a multi-sensor system, a first machine learning model employing the preferred set of data features.

In some aspects of an embodiment of the present invention, prior to training the first set of machine learning models on the first combination of the first set of data features, a processor gathers the set of training samples using the multi-sensor system at time t₀. A processor measures one or more data features of the set of training samples. A processor ranks each data feature of the one or more data features according to a degree of importance of each data feature. A processor extracts the first set of data features.

In some aspects of an embodiment of the present invention, subsequent to training the first set of machine learning models on the first combination of the first set of data features, a processor creates a pool of trained machine learning models, wherein the pool of trained machine learning models includes one or more machine learning models that have achieved a desired performance metric, and wherein each machine learning model uses a different combination of the first set of data features to achieve the desired performance metric.

In some aspects of an embodiment of the present invention, subsequent to creating the pool of trained machine learning models, a processor calibrates the multi-sensor system at time t₁>t₀ using a standardization technique to assess a state of health of a sensor of the multi-sensor system. A processor validates a calibration of the multi-sensor system to assess a degree of accuracy of a prediction of a machine learning model and to assess an extent of deviation of an actual value of each feature from an expected value of each feature.

In some aspects of an embodiment of the present invention, the standardization technique is at least one of a single wavelength standardization technique, a direct standardization technique, and a piece-wise direct-standardization technique.

In some aspects of an embodiment of the present invention, a processor compares the second set of data features to the first set of data features. A processor ranks each data feature of the second set of data features according to a deviation of the second set of data features from the first set of data features. A processor extracts the second set of data features.

In some aspects of an embodiment of the present invention, a processor determines a performance of the first machine learning model is below a pre-set accuracy threshold by performing an inference on the first machine learning model using one or more validation samples. A processor self-adjusts the first machine learning model to fulfill the desired performance metric.

In some aspects of an embodiment of the present invention, a processor selects a second machine learning model from the pool of trained machine learning models based a selection criterion based on a combined ranking of features, wherein the combined ranking of features is derived from a degree of importance of a feature and a degradation of the feature.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a self-adjusting multi-sensor program, on a server within the distributed data processing environment of FIG. 1, in accordance with an embodiment of the present invention;

FIG. 3 is a flowchart illustrating the operational steps of a training component of the self-adjusting multi-sensor program, on the server within the distributed data processing environment of FIG. 1, in accordance with an embodiment of the present invention;

FIG. 4 is a flowchart illustrating the operational steps of an inference component of the self-adjusting multi-sensor program, on the server within the distributed data processing environment of FIG. 1, in accordance with an embodiment of the present invention;

FIG. 5 is a functional block diagram illustrating the training component and the inference component of the self-adjusting multi-sensor program, in accordance with an embodiment of the present invention;

FIG. 6 is a process flow diagram illustrating interaction between different stages of the self-adjusting multi-sensor program used to determine a feature degradation, in accordance with an embodiment of the present invention; and

FIG. 7 depicts a block diagram of components of a computing environment representing the distributed data processing environment of FIG. 1, in accordance with an embodiment of the present invention.

### DETAILED DESCRIPTION

Embodiments of the present invention recognize that a multi-sensor system is a system comprised of two or more sensors responsible for collecting a set of data about a product and/or a process being tested over a period of time. Embodiments of the present invention recognize that a multi-sensor system employing Artificial Intelligence (AI), more specifically a machine learning (ML) technique, is becoming more prevalent and more widely used. A reason why the multi-sensor system employing AI is becoming more prevalent is because the multi-sensor system can perform more complex measurements and/or can provide an analysis of the product and/or process being tested and of the measurements performed.

Embodiments of the present invention recognize that a business with a product and/or process that interacts with a physical and/or chemical environment is an example of a business increasingly using a multi-sensor system employing AI, more specifically a machine learning technique, and relying on measurements obtained from and/or information provided about the product and/or process being tested. For example, the business may develop food and chemical products, analyze food and chemical products for innovation and quality control reasons, inspect physical infrastructure and chemical inventory, and/or monitor an environment for regulatory and sustainability compliance.

Embodiments of the present invention recognize that a sensor, in general, and a multi-sensor system employing AI, more specifically a machine learning technique, in particular, may change over a period of time because of an internal and/or an external influence. If a sensor and/or a multi-sensor system is changed over a period of time by some type of influence, then the measurements performed may also be affected. Embodiments of the present invention further recognize that a sensor, in general, and a multi-sensor system employing AI, more specifically a machine learning technique, in particular, may also face challenges associated with using AI to interact with the physical and chemical environment and obtaining measurements from and/or information provided about the product and/or process being tested. These challenges may include, but are not limited to, recognizing if a calibration procedure is sufficient for a multi-sensor system to be fit for continued use; identifying a specific feature that has degraded to the extent that the feature can no longer be sufficiently calibrated; and dealing with a degraded feature so that the overall multi-sensor system remains fit for continued use, or to be informed that the multi-sensor system is no longer fit for use and needs to be replaced.

Therefore, embodiments of the present invention recognize the need for a system and method to fill an important gap in an application of AI to measurements obtained from a sensor of a multi-sensor system. More specifically, embodiments of the present inventions recognize the need for a system and method to prepare and use an AI model in a real scenario where a sensor of a multi-sensor system is subject to variability and degradation over time, so that the variability and degradation can be detected when such variability and degradation becomes a problem for an AI model, causing it to become too inaccurate to support decision-making. Embodiments of the present inventions recognize the need for a system and method to implement a programmatic approach to adjust the AI model to continue to support the operation of a multi-sensor system that has been subject to variability and degradation over time.

Embodiments of the present invention provide a system and method to perform a self-adjustment of a multi-sensor data processing environment, wherein the system and method assesses a state of health (SoH) of a multi-sensor system, e.g., multi-sensor system 140_{1-N} for a characterization of a known and/or unknown product and/or process at one or several points in time t, and wherein self-adjusting multi-sensor program 122 identifies and mitigates a set of anomalous sensor data from the multi-sensor system (e.g., multi-sensor system 140_{1-N}) to enable a continued use of the multi-sensor system (e.g., multi-sensor system 140_{1-N}) for an intended purpose in practice. Embodiments of the present invention perform the assessment of the SoH of the multi-sensor system (e.g., multi-sensor system 140_{1-N}) after analyzing a sample from the multi-sensor system (e.g., multi-sensor system 140_{1-N}) to achieve the least possible degradation of performance during a usage of the multi-sensor system (e.g., multi-sensor system 140_{1-N}).

Implementation of embodiments of the present invention may take a variety of forms, and exemplary implementation details are discussed subsequently with reference to the Figures.

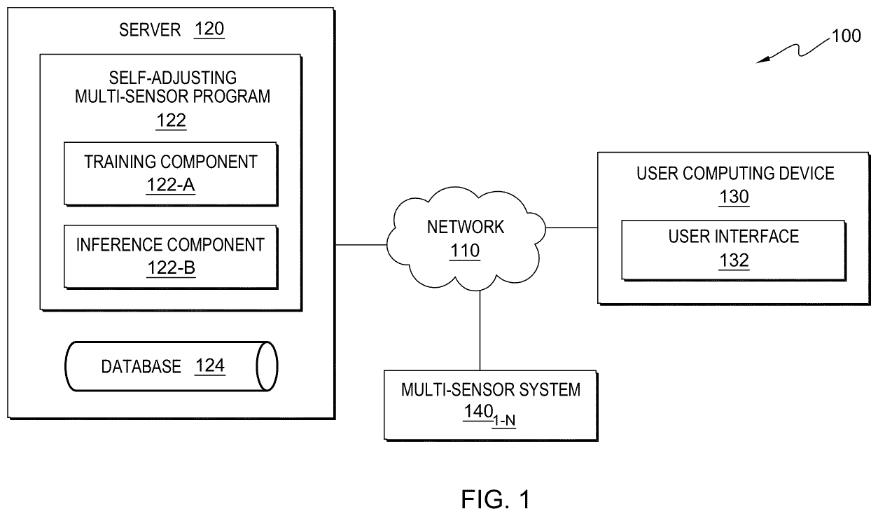

FIG. 1 is a block diagram illustrating a distributed data processing environment, generally designated 100, in accordance with an embodiment of the present invention. In the depicted embodiment, distributed data processing environment 100 includes server 120, user computing device 130, and multi-sensor system 140_{1-N}, interconnected over network 110. Distributed data processing environment 100 may include additional servers, computers, computing devices, sensors, other devices (not shown), and other sensors (not shown). The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, multi-sensor system 140_{1-N}, other computing devices (not shown), and other sensors (not shown) within distributed data processing environment 100.

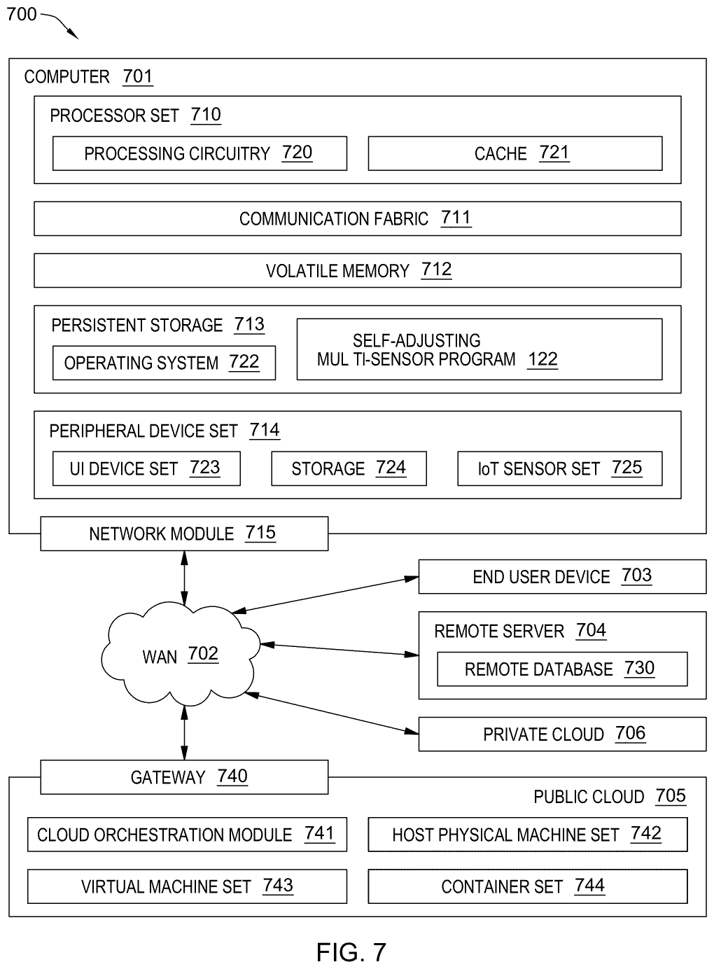

Server 120 operates to run self-adjusting multi-sensor program 122, to send and/or store data in database 124, and to send data to and/or receive data from multi-sensor system 140_{1-N}. In an embodiment, server 120 can send data from database 124 to user computing device 130 and/or multi-sensor system 140_{1-N}. In an embodiment, server 120 can receive data in database 124 from user computing device 130 and/or multi-sensor system 140_{1-N}. In an embodiment, server 120 includes self-adjusting multi-sensor program 122 and database 124. In one or more embodiments, server 120 can be a standalone computing device, a management server, a web server, a mobile computing device, or any other electronic device or computing system capable of receiving, sending, and processing data and capable of communicating with user computing device 130 and multi-sensor system 140_{1-N} via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130, multi-sensor system 140_{1-N}, other computing devices (not shown), and other sensors (not shown) within distributed data processing environment 100 via network 110. Server 120 may include internal and external hardware components, as depicted and described in further detail in FIG. 7.

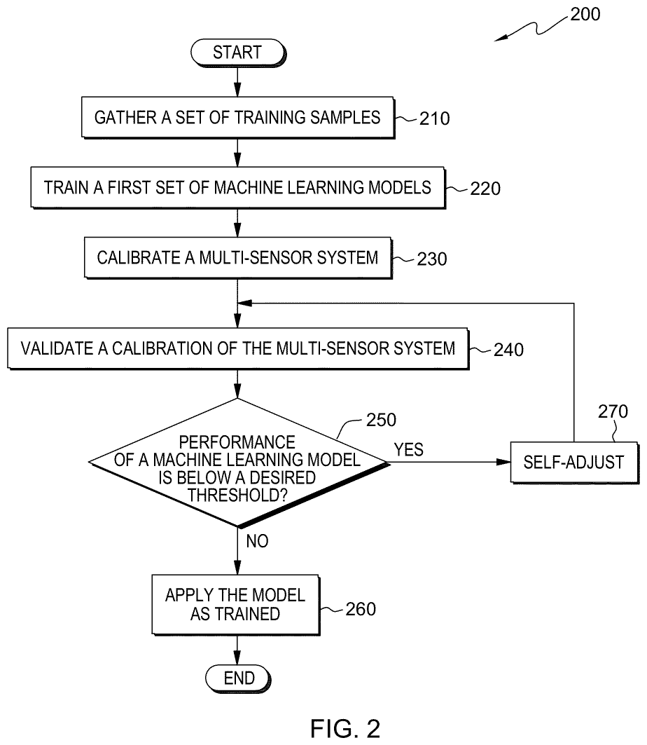

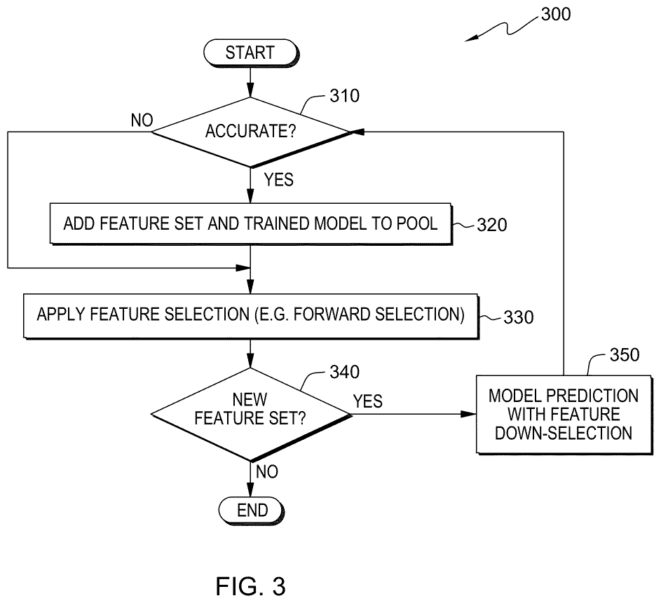

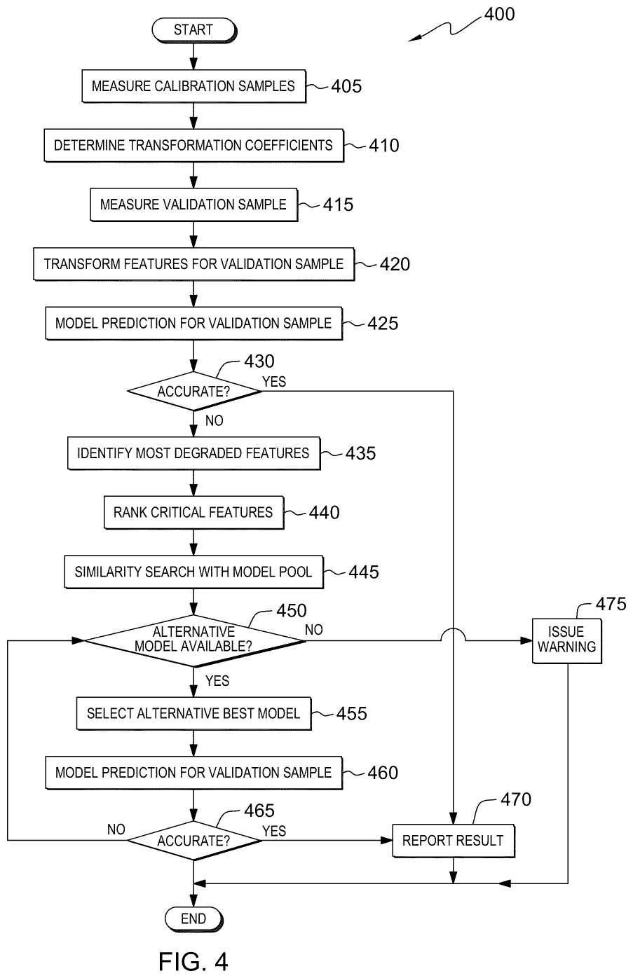

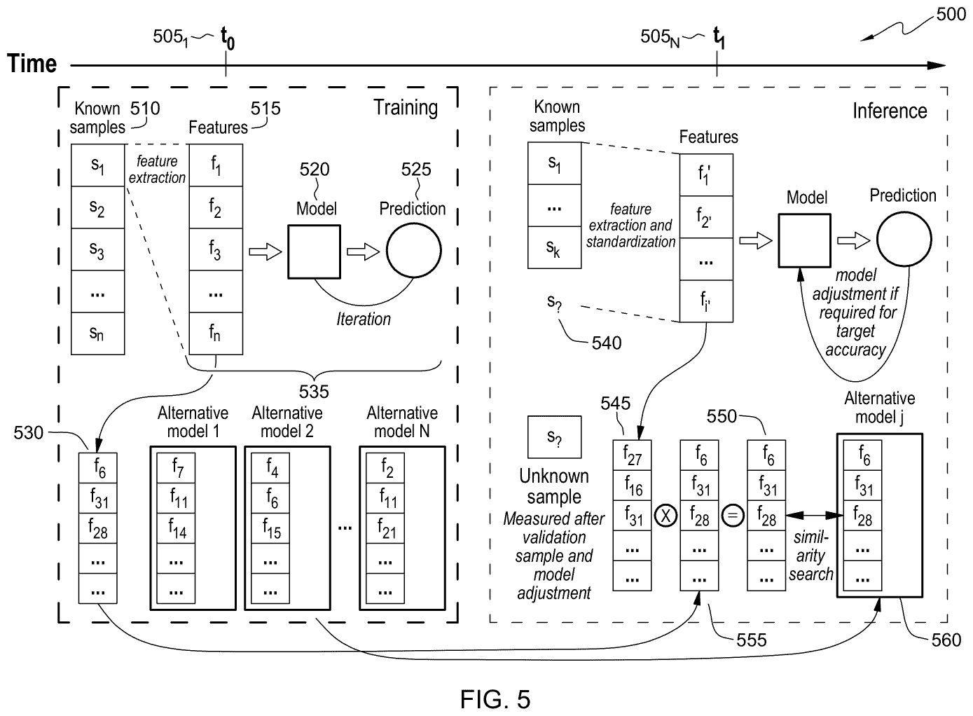

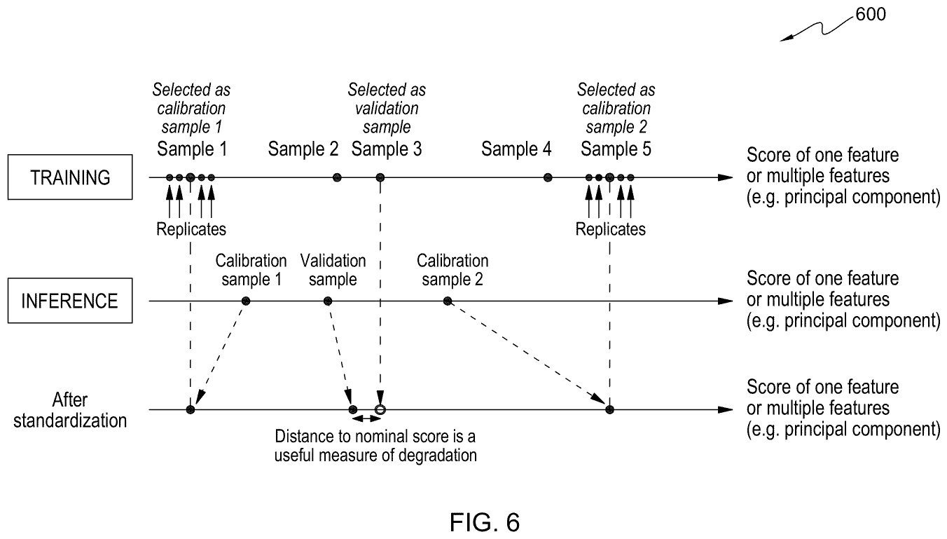

Self-adjusting multi-sensor program 122 operates to perform a self-adjustment of a multi-sensor data processing environment, wherein self-adjusting multi-sensor program 122 assesses a SoH of a multi-sensor system, e.g., multi-sensor system 140_{1-N}, for a characterization of a known and/or unknown product and/or process at one or several points in time t, and wherein self-adjusting multi-sensor program 122 identifies and mitigates a set of anomalous sensor data from the multi-sensor system (e.g., multi-sensor system 140_{1-N}) to enable a continued use of the multi-sensor system (e.g., multi-sensor system 140_{1-N}) for an intended purpose in practice. In the depicted embodiment, self-adjusting multi-sensor program 122 is a standalone program. In another embodiment, self-adjusting multi-sensor program 122 may be integrated into another software product. The operational steps of self-adjusting multi-sensor program 122 are depicted and described in further detail with respect to FIG. 2. The operational steps of training component 122-A of self-adjusting multi-sensor program 122 are depicted and described in further detail with respect to FIG. 3. The operational steps of inference component 122-B of self-adjusting multi-sensor program 122 are depicted and described in further detail with respect to FIG. 4. A function block diagram illustrating training component 122-A and inference component 122-B of self-adjusting multi-sensor program 122 is depicted and described in further detail with respect to FIG. 5. A process flow diagram illustrating interaction between different stages of self-adjusting multi-sensor program 122 to determine a feature degradation is depicted and described in further detail with respect to FIG. 6.

In an embodiment, a user of a user computing device (e.g., user computing device 130) registers with self-adjusting multi-sensor program 122 of server 120. For example, the user completes a registration process (e.g., user validation), provides information to create a user profile, and authorizes the collection, analysis, and distribution (i.e., opts-in) of relevant data on an identified computing device (e.g., user computing device 130) by server 120 (e.g., via self-adjusting multi-sensor program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by self-adjusting multi-sensor program 122. A database is an organized collection of data. Data includes, but is not limited to, information about user preferences (e.g., general user system settings such as alert notifications for a user computing device (e.g., user computing device 130)); information about alert notification preferences; a set of training samples (e.g., s₁, s₂, s₃, . . . , s_{N}) gathered and processed; and any other data received, used, and/or generated by self-adjusting multi-sensor program 122.

Database 124 can be implemented with any type of device capable of storing data and configuration files that can be accessed and utilized by server 120, such as a hard disk drive, a database server, or a flash memory. In an embodiment, database 124 is accessed by self-adjusting multi-sensor program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that self-adjusting multi-sensor program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Self-adjusting multi-sensor program 122 enables the authorized and secure processing of personal data and/or confidential company data.

Self-adjusting multi-sensor program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Self-adjusting multi-sensor program 122 provides information regarding personal and/or confidential company data and the nature (e.g., type, scope, purpose, duration, etc.) of the processing. Self-adjusting multi-sensor program 122 provides the user with copies of stored personal and/or confidential company data. Self-adjusting multi-sensor program 122 allows the correction or completion of incorrect or incomplete personal and/or confidential company data. Self-adjusting multi-sensor program 122 allows for the immediate deletion of personal and/or confidential company data.

User computing device 130 operates to run user interface 132 through which a user can interact with self-adjusting multi-sensor program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with self-adjusting multi-sensor program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between self-adjusting multi-sensor program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from self-adjusting multi-sensor program 122 to a user via network 110. User interface 132 can also display or present alerts including information (such as graphics, text, and/or sound) sent from self-adjusting multi-sensor program 122 to a user via network 110. In an embodiment, user interface 132 can send and receive data (i.e., to and from self-adjusting multi-sensor program 122 via network 110, respectively). Through user interface 132, a user can opt-in to self-adjusting multi-sensor program 122; input information; create a user profile; set user preferences and alert notification preferences; define a specification of a sample to be measured by the multi-sensor system; receive a request for feedback; and input feedback.

A user preference is a setting that can be customized for a particular user. A set of default user preferences are assigned to each user of self-adjusting multi-sensor program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of self-adjusting multi-sensor program 122.

Multi-sensor system 140_{1-N} operates to generate a set of measurement data when one or more sensors of multi-sensor system 140_{1-N} interact with one or more samples undergoing testing. As used herein, N represents a positive integer, and accordingly the number of scenarios implemented in a given embodiment of the present invention is not limited to those depicted in FIG. 1. In a preferred embodiment, multi-sensor system 140_{1-N} comprises an analog-to-digital conversion element to process a signal obtained from the one or more sensors of multi-sensor system 140_{1-N} via a data processing environment (e.g., data processing environment 100). In an embodiment, multi-sensor system 140_{1-N} can receive data from server 120 and user computing device 130. In an embodiment, multi-sensor system 140_{1-N} can send data to server 120 and user computing device 130. In the depicted embodiment, multi-sensor system 140_{1-N} is a standalone device.

FIG. 2 is a flowchart, generally designated 200, illustrating the operational steps of self-adjusting multi-sensor program 122, on server 120 within distributed data processing environment 100 of FIG. 1, in accordance with an embodiment of the present invention. In an embodiment, self-adjusting multi-sensor program 122 operates to perform a self-adjustment of a multi-sensor data processing environment, wherein self-adjusting multi-sensor program 122 assesses a SoH of a multi-sensor system, e.g., multi-sensor system 140_{1-N}, for a characterization of a known and/or unknown product and/or process at one or several points in time t, and wherein self-adjusting multi-sensor program 122 identifies and mitigates a set of anomalous sensor data from the multi-sensor system, e.g., multi-sensor system 140_{1-N}, to enable a continued use of the multi-sensor system, e.g., multi-sensor system 140_{1-N}, for an intended purpose in practice. It should be appreciated that the process depicted in FIG. 2 illustrates one possible iteration of the process flow, which may be repeated each time a user initiates self-adjusting multi-sensor program 122 and performs a series of test measurements repeated one after the other or within a short period of time using the multi-sensor system, e.g., multi-sensor system 140_{1-N}. In an embodiment, when a performance of a machine learning model is determined to be below a desired threshold, a subset of the operational steps of self-adjusting multi-sensor program 122 (i.e., steps 240, 250, and 270 of FIG. 2) may be repeated iteratively. The subset of the operational steps of self-adjusting multi-sensor program 122 includes a self-adjustment and a selection of an alternative machine learning model for processing data from the multi-sensor system, e.g., multi-sensor system 140_{1-N}.

In step 210, self-adjusting multi-sensor program 122 gathers and processes a set of training samples. A set of training samples are a set of known samples. A set of training samples includes, but is not limited to, one or more training samples that will be exposed to a multi-sensor system (e.g., multi-sensor system 140_{1-N}). In an embodiment, self-adjusting multi-sensor program 122 gathers a set of training samples (e.g., s₁, s₂, s₃, . . . , s_{N}). In an embodiment, self-adjusting multi-sensor program 122 gathers a set of training samples using a multi-sensor system, e.g., multi-sensor system 140_{1-N}. A multi-sensor system is a system comprised of two or more sensors. The two or more sensors are responsible for collecting a set of data about a known and/or unknown product and/or process at one or several points in time t. In an embodiment, self-adjusting multi-sensor program 122 gathers a set of training samples (e.g., s₁, s₂, s₃, . . . , s_{N}) at time t₀. In an embodiment, self-adjusting multi-sensor program 122 gathers a set of training samples (e.g., s₁, s₂, s₃, . . . , s_{N}) from a user. In an embodiment, self-adjusting multi-sensor program 122 enables a user to input a set of training samples when a machine learning model is initially being built. In an embodiment, self-adjusting multi-sensor program 122 gathers a set of training samples (e.g., s₁, s₂, s₃, . . . , s_{N}) from a database (e.g., database 124).

In an embodiment, self-adjusting multi-sensor program 122 processes the set of training samples (e.g., s₁, s₂, s₃, . . . , s_{N}). In an embodiment, self-adjusting multi-sensor program 122 processes the set of training samples (e.g., s₁, s₂, s₃, . . . , s_{N}) by measuring one or more data features of the set of training samples (e.g., s₁, s₂, s₃, . . . , s_{N}), extracting a first set of data features (e.g., f₁, f₂, f₃, . . . , fₖ) from the set of training samples (e.g., s₁, s₂, s₃, . . . , s_{N}), and ranking one or more data features of the first set of data features. In an embodiment, self-adjusting multi-sensor program 122 measures one or more data features of the set of training samples (e.g., s₁, s₂, s₃, . . . , s_{N}). In an embodiment, self-adjusting multi-sensor program 122 extracts a first set of data features (e.g., f₁, f₂, f₃, . . . fₖ). In an embodiment, self-adjusting multi-sensor program 122 extracts a first set of data features (e.g., f₁, f₂, f₃, . . . , fₖ) from a measurement of the one or more data features of the set of training samples (e.g., s₁, s₂, s₃, . . . , s_{N}). In an embodiment, self-adjusting multi-sensor program 122 ranks the one or more data features of the first set of data features (e.g., f₁, f₂, f₃, . . . , fₖ). In an embodiment, self-adjusting multi-sensor program 122 ranks one or more data features of the first set of data features (e.g., f₁, f₂, f₃, . . . fₖ) according to a degree of importance of each data feature. In an embodiment, self-adjusting multi-sensor program 122 assesses the degree of importance of each data feature through a supervised feature selection technique known to those skilled in the art. In another embodiment, self-adjusting multi-sensor program 122 assesses the degree of importance of each data feature through an unsupervised feature selection technique known to those skilled in the art. The unsupervised feature selection technique includes, but is not limited to, a filter method and a wrapper-based method. In an embodiment, self-adjusting multi-sensor program 122 ranks one or more data features of the first set of data features (e.g., f₁, f₂, f₃, . . . , fₖ) to obtain a first list of data features.

In step 220, self-adjusting multi-sensor program 122 trains a first set of machine learning models. In an embodiment, self-adjusting multi-sensor program 122 trains a first set of machine learning models using a supervised and/or self-supervised learning technique known to those skilled in the art. In an embodiment, self-adjusting multi-sensor program 122 trains a first set of machine learning models on a first combination of the first set of data features. In an embodiment, self-adjusting multi-sensor program 122 creates a pool of trained machine learning models. The pool of trained machine learning models includes, but is not limited to, one or more machine learning models that have achieved a desired performance metric. Each machine learning model of the pool of trained machine learning models uses a different combination of the first set of data features to achieve a desired performance metric. For example, a first machine learning model of the pool of trained machine learning models uses a combination of the first set of data features to fill a degree of classification accuracy, i.e., a desired performance metric. The training of the first set of machine learning models and the creation of the pool of trained machine learning models is described in further detail with respect to flowchart 300 in FIG. 3.

In step 230, self-adjusting multi-sensor program 122 calibrates the multi-sensor system, e.g., multi-sensor system 140_{1-N}. In an embodiment, self-adjusting multi-sensor program 122 calibrates the multi-sensor system, e.g., multi-sensor system 140_{1-N} at time t₁>t₀. In an embodiment, self-adjusting multi-sensor program 122 calibrates the multi-sensor system, e.g., multi-sensor system 140_{1-N}, using a standardization technique known to those skilled in the art. The standardization technique known to those skilled in the art includes, but is not limited to, a Single Wavelength Standardization, a Direct Standardization, or a Piece-Wise Direct-Standardization. In an embodiment, self-adjusting multi-sensor program 122 calibrates the multi-sensor system, e.g., multi-sensor system 140_{1-N}, to assess a SOH of a sensor of the multi-sensor system, e.g., multi-sensor system 140_{1-N}. In an embodiment, self-adjusting multi-sensor program 122 calibrates the multi-sensor system, e.g., multi-sensor system 140_{1-N}, to compensate for an undesirable change in a sensor output. A reason for an undesirable change in a sensor output includes, but is not limited to, aging, sensor damage and degradation of performance. In an embodiment, self-adjusting multi-sensor program 122 calibrates the multi-sensor system, e.g., multi-sensor system 140_{1-N}, to determine a coefficient needed to transform, as best as possible, a feature matrix F(t₁) at time t₁ to match a feature F(t₀) at time t₀ for a known sample (i.e., a “calibration sample”). For a linear transformation, an equation F′(t₁)=TF(t₁)˜F(t₀) is used. F′(t₁) is defined as a feature extracted from a set of data recorded at time t₁ after a transformation and T is defined as a matrix of a transformation coefficient. The number of calibration samples is significantly smaller than the number of training samples (e.g., by one order of magnitude), which makes calibration easier than training and therefore is strongly preferred for practical use of the multi-sensor system, e.g., multi-sensor system 140_{1-N}. Step 230 is described in further detail with respect to flowchart 400 in FIG. 4.

In step 240, self-adjusting multi-sensor program 122 validates a calibration of the multi-sensor system, e.g., multi-sensor system 140_{1-N}. In an embodiment, self-adjusting multi-sensor program 122 validates a calibration of the multi-sensor system, e.g., multi-sensor system 140_{1-N} to assess a degree of accuracy of a prediction of a first machine learning model. In an embodiment, self-adjusting multi-sensor program 122 validates a calibration of the multi-sensor system, e.g., multi-sensor system 140_{1-N}, to assess an extent of deviation of each feature's actual value from each feature's expected value (i.e., a “feature degradation”). In an embodiment, self-adjusting multi-sensor program 122 measures a sub-set of training samples (i.e., a “validation sample” or “validation samples”) to provide a second set of data features. In an embodiment, self-adjusting multi-sensor program 122 compares the second set of data features to the first set of data features. In an embodiment, self-adjusting multi-sensor program 122 ranks the second set of data features. In an embodiment, self-adjusting multi-sensor program 122 ranks the second set of data features according to a deviation of the second set of data features from the first set of data features. In an embodiment, self-adjusting multi-sensor program 122 obtains a second list of data features. Step 240 is described in further detail with respect to flowchart 400 in FIG. 4.

In decision step 250, self-adjusting multi-sensor program 122 determines whether a performance (i.e., measured in terms of a degree of accuracy) of the first machine learning model is below a pre-set accuracy threshold (i.e., a desired prediction performance, i.e., an expected value). In an embodiment, self-adjusting multi-sensor program 122 determines whether a performance of the first machine learning model is below a pre-set accuracy threshold by performing an inference of the first machine learning model on one or more validation samples that are known samples but not part of the set of calibration samples. In an embodiment, self-adjusting multi-sensor program 122 performs the inference of the first machine learning model. In an embodiment, self-adjusting multi-sensor program 122 assesses the inference of the first machine learning model by a level of confidence of an inference result of the first machine learning model. In an embodiment, self-adjusting multi-sensor program 122 measures the validation sample a plurality of times and takes the percentage of correct predictions by the first machine learning model as the performance of the first machine learning model. In an embodiment, self-adjusting multi-sensor program 122 recognizes that the accuracy threshold depends on a specification imposed by a user regarding a level of confidence that is expected for an application of the first machine learning model. The specification imposed by the user includes, but is not limited to, an uncertainty level that is considered acceptable according to a quality control standard. In an embodiment, responsive to the performance (i.e., the degree of accuracy) of the first machine learning model exceeding the pre-set accuracy threshold (i.e., the desired prediction performance, i.e., the expected value) (decision step 250, NO branch), self-adjusting multi-sensor program 122 proceeds to step 260, applying the first machine learning model as trained on F(t₀) at time t₀. In an embodiment, responsive to the performance (i.e., the degree of accuracy) of the first machine learning model not exceeding the pre-set accuracy threshold (i.e., the desired prediction performance, i.e., the expected value) (decision step 250, YES branch), self-adjusting multi-sensor program 122 proceeds to step 270, self-adjusting.

In step 260, self-adjusting multi-sensor program 122 applies the first machine learning model as trained on F(t₀) at time t₀. In an embodiment, responsive to the performance of the first machine learning model exceeding the pre-set accuracy threshold, self-adjusting multi-sensor program 122 applies the first machine learning model as trained on F(t₀) at time t₀. In an embodiment, self-adjusting multi-sensor program 122 applies the first machine learning model as trained on F(t₀) at time t₀ to the transformed features F′(t₁) at t₁ without having to retrain the first machine learning model at t₁.

In step 270, self-adjusting multi-sensor program 122 self-adjusts. In an embodiment, responsive to the performance of the first machine learning model not exceeding the pre-set accuracy threshold, self-adjusting multi-sensor program 122 self-adjusts. In an embodiment, self-adjusting multi-sensor program 122 self-adjusts to fulfill the pre-set accuracy threshold (i.e., the desired performance metric, i.e., the expected value). In an embodiment, self-adjusting multi-sensor program 122 self-adjusts by selecting a second machine learning model from the pool of trained machine learning models. In an embodiment, self-adjusting multi-sensor program 122 selects a second machine learning model from the pool of trained machine learning models. In an embodiment, self-adjusting multi-sensor program 122 selects a second machine learning model based on a selection criterion based on a combined ranking of features. The combined ranking of features is derived from an importance of a feature and a degradation of a feature.

FIG. 3 is a flowchart, generally designated 300, illustrating, in greater detail, the operational steps of a training component (e.g., training component 122-A) of self-adjusting multi-sensor program 122, on server 120 within distributed data processing environment 100 of FIG. 1, in accordance with an embodiment of the present invention. In an embodiment, the training component (e.g., training component 122-A) of self-adjusting multi-sensor program 122 operates to train a machine learning model using a supervised and/or self-supervised learning technique, to produce a combination of selected data features, and to repeat the training for the combination of selected data features. It should be appreciated that the process depicted in FIG. 3 illustrates one possible iteration of the training component (e.g., training component 122-A) of self-adjusting multi-sensor program 122, which may be repeated until the feature selection method (e.g., forward selection) has provided all possible combinations of selected data features over which the method of FIG. 3 will be repeated (i.e., repeated for each combination of selected data features).

In decision step 310, self-adjusting multi-sensor program 122 determines whether a first machine learning model is accurate. In an embodiment, self-adjusting multi-sensor program 122 repeats decision step 310 to determine whether each machine learning model in the pool of trained machine learning models is accurate. In an embodiment, responsive to training a first set of machine learning model using a supervised and/or self-supervised learning technique on a first combination of the first set of data features (e.g., in step 220 of FIG. 2), self-adjusting multi-sensor program 122 determines whether a first machine learning model is accurate. In an embodiment, self-adjusting multi-sensor program 122 pre-sets an accuracy threshold. The accuracy threshold depends on a specification imposed by the user regarding a level of confidence that is expected. The specification imposed by the user includes, but is not limited to, an uncertainty level that is considered acceptable according to a quality control standard. In an embodiment, self-adjusting multi-sensor program 122 determines whether a first machine learning model is accurate by performing a validation and/or testing of the first machine learning model on a set of data obtained from a measurement of samples. In an embodiment, self-adjusting multi-sensor program 122 determines an accuracy of a classification machine learning model using a k-fold cross-validation method known to those skilled in the art on all sample data. In an embodiment, self-adjusting multi-sensor program 122 determines an accuracy of a classification machine learning model by causing the first machine learning model (i.e., trained on a first set of sample data) to perform an inference on a second set of sample data. In an embodiment, self-adjusting multi-sensor program 122 determines an accuracy of a regression machine learning model by computing an error of an inference of the regression machine learning model on a set of test sample data that was not included during the training of the regression machine learning model. In an embodiment, self-adjusting multi-sensor program 122 defines a desirable performance of a machine learning model by a human or machine agent as a minimum accuracy or a maximum error relative to an application context of the multi-sensor system, e.g., multi-sensor system 140_{1-N}. If self-adjusting multi-sensor program 122 determines the first machine learning model is accurate (decision step 310, YES branch), then self-adjusting multi-sensor program 122 proceeds to step 320, adding the first set of data features extracted and the first machine learning model to a pool of trained machine learning models. If self-adjusting multi-sensor program 122 determines the first machine learning model is not accurate (decision step 310, NO branch), then self-adjusting multi-sensor program 122 proceeds to step 330, applying a feature selection.

In step 320, self-adjusting multi-sensor program 122 adds the first set of data features extracted and the first machine learning model to a pool of trained machine learning models. In an embodiment, self-adjusting multi-sensor program 122 constructs a pool of trained machine learning models. The pool of trained machine learning models may also be referred to as a “model pool”. Each machine learning model of the pool of trained machine learning models may use a different combination of one or more features. The different combination of the one or more features may be derived from the multi-sensor system, e.g., multi-sensor system 140_{1-N}. The different combination of the one or more features may be derived based on the desirable performance to be achieved. For example, the one or more features may be derived based on a classification accuracy, i.e., the desired performance to be achieved.

In step 330, self-adjusting multi-sensor program 122 applies a feature selection. A feature selection is a selection of a set of sensor data to train a machine learning model. If a machine learning model satisfies the accuracy requirements, the machine learning model will be added to the pool of trained machine learning models. A forward feature selection is an example of a feature selection. A forward feature selection enables a generation of a finite set of feature sets. In an embodiment, self-adjusting multi-sensor program 122 applies a forward feature selection known to those skilled in the art. In an embodiment, self-adjusting multi-sensor program 122 applies a forward feature selection to produce a new set of data features. In an embodiment, self-adjusting multi-sensor program 122 applies a forward feature selection to find a minimal set of data features that allow the machine learning model to achieve the desired performance. In an embodiment, self-adjusting multi-sensor program 122 applies a backward feature elimination to find a comprehensive set of data features that allow the machine learning model to achieve the desired performance.

In decision step 340, self-adjusting multi-sensor program 122 determines whether a new set of one or more data features exists. In an embodiment, self-adjusting multi-sensor program 122 determines whether a new set of one or more data features exists by comparing a newly generated set of one or more data features from the feature selection (i.e., from step 330) to the sets of one or more data features that were previously used to train a set of machine learning models (i.e., in step 220). In an embodiment, self-adjusting multi-sensor program 122 determines whether a set of one or more data features has been used to train a new machine learning model, and thus, is a machine learning model that has been already tested for possible insertion in the pool of trained machine learning models by recursively applying a feature selection method. In an embodiment, self-adjusting multi-sensor program 122 determines whether a new set of one or more data features exists to avoid a redundant training of a machine learning model. If self-adjusting multi-sensor program 122 determines a new set of one or more data features exists (decision step 340, YES branch), then self-adjusting multi-sensor program 122 proceeds to step 350, modeling a prediction with the new set of one or more data features. If self-adjusting multi-sensor program 122 determines a new set of one or more data features does not exist (decision step 340, NO branch), then self-adjusting multi-sensor program 122 ends.

In step 350, self-adjusting multi-sensor program 122 models a prediction with the new set of one or more data features (i.e., identified in step 340). A prediction corresponds to an inference of a machine learning model. In an embodiment, in the case of a classification machine learning model, self-adjusting multi-sensor program 122 models a prediction using a k-fold cross-validation method known to those skilled in the art on all sample data. In an embodiment, self-adjusting multi-sensor program 122 determines an accuracy of a classification machine learning model by causing the machine learning model trained on a first set of sample data to perform an inference on a second set of sample data. In an embodiment, self-adjusting multi-sensor program 122 pre-sets an accuracy threshold. The accuracy threshold depends on a specification imposed by the user regarding a level of confidence that is expected. The specification imposed by the user includes, but is not limited to, an uncertainty level that is considered acceptable according to a quality control standard. In an embodiment, self-adjusting multi-sensor program 122 determines an accuracy of a regression machine learning model by computing an error of an inference of the regression machine learning model on a set of test sample data that was not included during the training of the regression machine learning model. In an embodiment, self-adjusting multi-sensor program 122 compares the prediction of the machine learning model (i.e., from step 350) to a desirable performance of the machine learning model (e.g., such as a classification accuracy, i.e., in step 310), thus, repeating the cycle of generating a new set of one or more data features and machine learning models and adding the machine learning models to the pool of trained machine learning models (i.e., as used in step 220).

FIG. 4 is a flowchart, generally designated 400, illustrating, in greater detail, the operational steps of an inference component (e.g., inference component 122-B) of self-adjusting multi-sensor program 122 (e.g., steps 230 and 240 of FIG. 2), on server 120 within distributed data processing environment 100 of FIG. 1, in accordance with an embodiment of the present invention. In an embodiment, the inference component (e.g., inference component 122-B) of self-adjusting multi-sensor program 122 operates to calibrate the multi-sensor system, e.g., multi-sensor system 140_{1-N}, to validate a trained machine learning model from the pool of trained machine learning models, to determine whether self-adjustment is necessary, to perform such self-adjustment, if necessary, and to apply a trained machine learning model from the pool of trained machine learning models for processing of multi-sensor system data obtained by measurement of a sample undergoing testing. In an embodiment, the inference component (e.g., inference component 122-B) of self-adjusting multi-sensor program 122 operates prior to an inference session (i.e., a testing of a plurality of samples to produce a plurality of corresponding predictions). In an embodiment, if a machine learning model prediction for a validation sample is not satisfactory (i.e., in step 430), then the inference component (e.g., inference component 122-B) of self-adjusting multi-sensor program 122 operates to identify and rank the most degraded features (i.e., in steps 435 and 440) in order to identify a set of trained machine learning models that are part of the pool of trained machine learning models (i.e., in step 445 and generated as a result of a process in FIG. 3) and that contain machine learning models trained with the least degraded features. It should be appreciated that the process depicted in FIG. 4 illustrates one possible iteration of the inference component (e.g., inference component 122-B) of self-adjusting multi-sensor program 122, which may be repeated in part for each iteration of the self-adjustment. In an embodiment, the inference component (e.g., inference component 122-B) of self-adjusting multi-sensor program 122 repeatedly operates in its entirety for each new measurement of a sample undergoing testing, starting after a new sample undergoing testing has been measured, typically at a time t₁>t₀.

In step 405, self-adjusting multi-sensor program 122 measures one or more calibration samples. In an embodiment, self-adjusting multi-sensor program 122 measures one or more calibration samples based on one or more signals generated by a transduction mechanism offered by one or more sensors of the multi-sensor system, e.g., multi-sensor system 140_{1-N}. A measurement by the multi-sensor system, e.g., multi-sensor system 140_{1-N}, may produce a plurality of data outputs and, depending on a measurement principle of the one or more sensors of the multi-sensor system, e.g., multi-sensor system 140_{1-N}, the plurality of data outputs may have one or more units of measurement. For example, a sensor signal may be generated electrochemically by a first method from a first set of one or more methods. The first set of one or more methods include, but are not limited to, potentiometry, voltammetry, amperometry, or impedimetry. In another embodiment, a sensor signal may be generated by a second method from a second set of one or more methods. The second set of one or more methods include, but are not limited to, optically, electrically, magnetically, or thermally. In an embodiment, self-adjusting multi-sensor program 122 identifies and stores the sets of data features associated with the one or more calibration samples for subsequent steps.

In step 410, self-adjusting multi-sensor program 122 determines a set of transformation coefficients. In an embodiment, self-adjusting multi-sensor program 122 determines a set of transformation coefficients through a mathematical operation in a form of a statistical method. In another embodiment, self-adjusting multi-sensor program 122 determines a set of transformation coefficients through a mathematical operation in a form of a machine learning approach. In an embodiment, self-adjusting multi-sensor program 122 determines a set of transformation coefficients by comparing one or more sets of data features obtained from the one or more calibration samples measured at time t₁ with one or more sets of data features obtained from the one or more calibration samples measured at time t₀.

In an embodiment, self-adjusting multi-sensor program 122 calibrates the multi-sensor system, e.g., multi-sensor system 140_{1-N}. In an embodiment, self-adjusting multi-sensor program 122 calibrates the multi-sensor system, e.g., multi-sensor system 140_{1-N} at time t₁>t₀. In an embodiment, self-adjusting multi-sensor program 122 calibrates the multi-sensor system, e.g., multi-sensor system 140_{1-N} using a standardization technique known to those skilled in the art. The standardization technique known to those skilled in the art includes, but is not limited to, a Single Wavelength Standardization, a Direct Standardization, or a Piece-Wise Direct-Standardization. In an embodiment, self-adjusting multi-sensor program 122 calibrates the multi-sensor system, e.g., multi-sensor system 140_{1-N}, to assess a SOH of a sensor of the multi-sensor system, e.g., multi-sensor system 140_{1-N}. In an embodiment, self-adjusting multi-sensor program 122 calibrates the multi-sensor system, e.g., multi-sensor system 140_{1-N}, to compensate for an undesirable change in a sensor output. A reason for an undesirable change in a sensor output includes, but is not limited to, aging, sensor damage and degradation of performance. In an embodiment, self-adjusting multi-sensor program 122 calibrates the multi-sensor system, e.g., multi-sensor system 140_{1-N}, to determine a coefficient needed to transform, as best as possible, a feature matrix F(t₁) at time t₁ to match a feature F(t₀) at time t₀ for a known sample (i.e., a “calibration sample”). For a linear transformation, an equation F′(t₁)=TF(t₁)˜F(t₀) is used. F′(t₁) is defined as a feature extracted from a set of data recorded at time t₁ after a transformation and T is defined as a matrix of a transformation coefficient. In an embodiment, self-adjusting multi-sensor program 122 performs the transformation of the feature matrix F(t₁) at time t₁ to match a feature F(t₀) at time t₀ for the one or more calibration samples using a standardization technique known to those skilled in the art. The number of calibration samples is significantly smaller than the number of training samples (e.g., by one order of magnitude), which makes calibration easier than training and therefore is strongly preferred for practical use of the multi-sensor system, e.g., multi-sensor system 140_{1-N}. Step 230 is described in further detail with respect to flowchart 400 in FIG. 4.

In step 415, self-adjusting multi-sensor program 122 measures one or more validation samples. In an embodiment, self-adjusting multi-sensor program 122 measures one or more validation samples based on one or more signals generated by a transduction mechanism offered by one or more sensors of the multi-sensor system, e.g., multi-sensor system 140_{1-N}. A measurement by the multi-sensor system, e.g., multi-sensor system 140_{1-N}, may produce a plurality of data outputs and, depending on a measurement principle of the one or more sensors of the multi-sensor system, e.g., multi-sensor system 140_{1-N}, the plurality of data outputs may have one or more units of measurement. The one or more validation samples are distinct from the aforementioned one or more calibration samples. In an embodiment, self-adjusting multi-sensor program 122 identifies one or more sets of data features associated with the one or more validation samples. In an embodiment, self-adjusting multi-sensor program 122 stores one or more sets of data features associated with the one or more validation samples for subsequent steps. In an embodiment, self-adjusting multi-sensor program 122 stores one or more sets of data features associated with the one or more validation samples for subsequent steps in a database (e.g., database 124).

In step 420, self-adjusting multi-sensor program 122 transforms the one or more sets of data features associated with the one or more validation samples. In an embodiment, self-adjusting multi-sensor program 122 transforms the one or more sets of data features associated with the one or more validation samples according to the set of transformation coefficients determined (i.e., in step 410), thus allowing, in principal, a machine learning model trained at time t₀ to be applied to an inference over the measurement data obtained from the one or more validation samples at time t₁. In an embodiment, self-adjusting multi-sensor program 122 transforms the one or more sets of data features associated with the one or more validation samples to produce an adjusted version of the same feature (i.e., the output of the transformation has the same “form” of original features but the values are modified).

In step 425, self-adjusting multi-sensor program 122 models a prediction for the one or more validation samples. In an embodiment, self-adjusting multi-sensor program 122 models a prediction for the one or more validation samples by applying a trained machine learning model to perform an inference on the transformed sets of data features associated with the one or more validation samples. The prediction for the one or more validation samples is the result of the inference step using the machine learning model trained with data from the multi-sensor system, e.g., multi-sensor system 140_{1-N} (e.g., step 220 in FIG. 2). In an embodiment, the machine learning model may be a classification model. In another embodiment, the machine learning model may be a regression model. In an embodiment, the predication for the one or more validation samples may be a classification result, and a confidence level of the machine learning model in a known correct classification result is used as a measure of performance and/or accuracy. In another embodiment, the prediction for the one or more validation samples may be a regression result, and a deviation of the predicted regression result from known correct properties of the one or more validation samples is used as a measure of performance and/or accuracy.

In decision step 430, self-adjusting multi-sensor program 122 determines whether the model prediction for the one or more validation samples is accurate. In an embodiment, self-adjusting multi-sensor program 122 determines whether the model prediction for the one or more validation samples is accurate by comparing the prediction of the machine learning model with a ground truth properties of the one or more validation samples. In an embodiment, the machine learning model predication may be a classification result, and the confidence level of the machine learning model in the known correct classification result is used as a measure of performance and/or accuracy. In another embodiment, the machine learning model prediction may be a regression result, and the deviation of the predicted regression result from the known correct properties of the one or more validation samples is used as a measure of performance and/or accuracy. In an embodiment, self-adjusting multi-sensor program 122 assesses an accuracy of the machine learning model prediction. In an embodiment, self-adjusting multi-sensor program 122 assesses whether the accuracy of the machine learning model prediction exceeds a pre-set user defined threshold. If self-adjusting multi-sensor program 122 determines the model prediction for the one or more validation samples is accurate (decision step 430, YES branch), then self-adjusting multi-sensor program 122 proceeds to step 470, reporting the results, whereby the results notably comprise the model prediction from the inference performed on the sample undergoing test measured at time t₁. If self-adjusting multi-sensor program 122 determines the model prediction for the one or more validation samples is not accurate (decision step 430, NO branch), then self-adjusting multi-sensor program 122 proceeds to step 435, identifying a set of at least one or more degraded features.

In step 435, self-adjusting multi-sensor program 122 identifies a set of at least one or more degraded features. In an embodiment, self-adjusting multi-sensor program 122 identifies a set of at least one or more degraded features by computing a degree of degradation of features. In an embodiment, self-adjusting multi-sensor program 122 computes a degree of degradation of features by observing a difference between the set of data features related to the one or more validation samples at time t₁ and the set of data features related to the same samples at a previous moment in time, such as time t₀. In an embodiment, t is identified based on an expected deviation from the expected feature score obtained from the same sample undergoing testing (e.g., the validation sample). In an embodiment, if the difference between two or more individual features comprised within the sets of data features pertaining to the validation samples at two different points in time is larger, then the extent of degradation of those features is greater. In an embodiment, self-adjusting multi-sensor program 122 computes a ranked list of features in order of extent of degradation. For example, self-adjusting multi-sensor program 122 sorts the features from least degraded to most degraded, and stores the ranked list of degraded features for subsequent steps.

In step 440, self-adjusting multi-sensor program 122 computes a ranked list of one or more critical features. A critical feature is a feature that has a high ranking based on the feature having a high degree of degradation and high importance for the machine learning predictive model at the same time. A critical feature provides necessary information for the self-adjustment process. A critical feature may also be referred to as a preferred feature. In an embodiment, self-adjusting multi-sensor program 122 combines the ranked feature importance list (i.e., from steps 210 and/or 220 of FIG. 2) with the ranked feature degradation list (i.e., from step 240 and from step 435 of FIG. 4) using a rank aggregation technique known to those skilled in the art. In an embodiment, self-adjusting multi-sensor program 122 identifies one or more critical features. In an embodiment, self-adjusting multi-sensor program 122 computes a ranked list of the one or more critical features. In an embodiment, self-adjusting multi-sensor program 122 computes a ranked list of the one or more critical features according to a combination of the ranked feature importance list with the ranked feature degradation list. In an embodiment, self-adjusting multi-sensor program 122 computes the ranked list of one or more critical features using a correlation-based method known to those skilled in the art. The correlation-based method includes, but is not limited to, an average ranking and/or a medium ranking, a Bayesian method for ranking data aggregation, and a Kendall's tau and/or a Spearman's footrule distance. In an embodiment, self-adjusting multi-sensor program 122 computes a ranked list of one or more critical features to arrange the list of one or more critical features in order and with the one or more critical features that are both least degraded and most important to the machine learning model. In an embodiment, self-adjusting multi-sensor program 122 recommends for use by the multi-sensor system, e.g., multi-sensor system 140_{1-N}, the trained machine learning model employing the ranked list of one or more critical features.

In step 445, self-adjusting multi-sensor program 122 searches for a similarity. In an embodiment, self-adjusting multi-sensor program 122 searches for a similarity between the list of one or more critical features and the lists of data features selected in at least two iterations of step 320. In an embodiment, self-adjusting multi-sensor program 122 searches for a similarity from the training of at least two machine learning models in the pool of trained machine learning models. In an embodiment, self-adjusting multi-sensor program 122 searches for a similarity using any pair-wise similarity metric that determines a degree of similarity between two objects. For example, self-adjusting multi-sensor program 122 searches for a similarity using a comparison run between the ranked list of one or more critical features and each of the feature sets belonging to the pool of trained machine learning models. In an embodiment, self-adjusting multi-sensor program 122 determines the similarity using a rank correlation method known to those of ordinary skill in the art. A rank correlation coefficient is determined by one or more methods. The one or more methods include, but are not limited to, the Spearman method, the Kendall method, and the signed-rank test of Wilcoxon.

In decision step 450, self-adjusting multi-sensor program 122 determines whether an alternative machine learning model is available. In an embodiment, self-adjusting multi-sensor program 122 determines whether an alternative machine learning model is available by examining a list of machine learning models in the pool of trained machine learning models, ranked according to the result of the similarity search (i.e., in step 445). In an embodiment, self-adjusting multi-sensor program 122 determines whether an alternative machine learning model is available based on a success of a similarity search procedure. In an embodiment, self-adjusting multi-sensor program 122 determines whether an alternative machine learning model is available by checking if at least one machine learning model is present in the pool of trained machine learning models and has not already been applied to perform an inference at time t₁. If self-adjusting multi-sensor program 122 determines an alternative machine learning model is available (decision step 450, YES branch), then self-adjusting multi-sensor program 122 proceeds to step 455, selecting an alternative machine learning model. If self-adjusting multi-sensor program 122 determines an alternative model is not available (decision step 450, NO branch), then self-adjusting multi-sensor program 122 proceeds to step 475, issuing a warning.

In step 455, self-adjusting multi-sensor program 122 selects an alternative machine learning model. The alternative machine learning model is a machine learning model trained on the set of data features exhibiting the highest similarity score compared to the list of one or more critical features. The list of one or more critical features includes, but is not limited to, a feature that is most important to the machine learning model and a feature that is least important to the machine learning model. Therefore, a machine learning model trained on the list of critical features offers the greatest chance of high performance at time t₁.

In step 460, self-adjusting multi-sensor program 122 models a prediction for the one or more validation samples. In an embodiment, self-adjusting multi-sensor program 122 models a prediction for the one or more validation samples by applying the alternative machine learning model to perform an inference on the transformed sets of data features for the one or more validation samples. In an embodiment, the machine learning model may be a classification model or a regression model. In an embodiment, the predication may be a classification result, and the confidence level of the machine learning model in the known correct classification result is used as a measure of performance and/or accuracy. In an embodiment, the prediction may be a regression result, and the deviation of the predicted regression result from the known correct properties of the one or more validation samples is used as a measure of performance and/or accuracy.

In decision step 465, self-adjusting multi-sensor program 122 determines whether the prediction for the one or more validation samples is accurate. In an embodiment, self-adjusting multi-sensor program 122 determines whether the prediction for the one or more validation samples is accurate by comparing the machine learning model prediction as obtained from an inference with a machine learning model with the ground truth property of the one or more validation samples. In an embodiment, the machine learning model predication may be a classification result, and the confidence level of the machine learning model in the known correct classification result is used as a measure of performance and/or accuracy. In an embodiment, the machine learning model prediction may be a regression result, and the deviation of the predicted regression result from the known correct properties of the one or more validation samples is used as a measure of performance and/or accuracy. In an embodiment, self-adjusting multi-sensor program 122 estimates an accuracy of the machine learning model prediction. In an embodiment, self-adjusting multi-sensor program 122 assesses whether the accuracy of the machine learning model prediction is above a user-defined threshold. If self-adjusting multi-sensor program 122 determines the prediction for the one or more validation samples is accurate (decision step 465, YES branch), then self-adjusting multi-sensor program 122 proceeds to step 470, reporting the results. If self-adjusting multi-sensor program 122 determines the prediction for the one or more validation samples is not accurate (decision step 465, NO branch), then self-adjusting multi-sensor program 122 returns to decision step 450, selecting the alternative machine learning model. In an embodiment, self-adjusting multi-sensor program 122 may return to decision step 450 until self-adjusting multi-sensor program 122 determines the prediction for the one or more validation samples is accurate, or until there are no alternative models available. When there are no alternative models available, self-adjusting multi-sensor program 122 ends.

In step 470, self-adjusting multi-sensor program 122 reports the results. In an embodiment, self-adjusting multi-sensor program 122 reports the results to the user. In an embodiment, self-adjusting multi-sensor program 122 enables the user to take an appropriate action based on the results reported. In an embodiment, self-adjusting multi-sensor program 122 uploads the results to a database (e.g., database 124) via a network (e.g., network 110). In an embodiment, self-adjusting multi-sensor program 122 stores the results in a database (e.g., database 124). The results include, but are not limited to, a classification result and a regression result that conveys a set of information to at least one of the user and the machine agent about one or more properties of the sample undergoing testing.

In step 475, self-adjusting multi-sensor program 122 issues a warning. In an embodiment, self-adjusting multi-sensor program 122 issues a warning to at least one of the user and the machine agent. In an embodiment, self-adjusting multi-sensor program 122 issues a warning that an alternative model is not available.

FIG. 5 depicts a functional block diagram, generally designated 500, illustrating a training component (e.g., training component 122-A) and an inference component (e.g., inference component 122-B) of self-adjusting multi-sensor program 122, on server 120 within distributed data processing environment 100 of FIG. 1, in accordance with an embodiment of the present invention.

In an embodiment, at time t₀ (e.g., 5051), self-adjusting multi-sensor program 122 gathers a set of training samples (e.g., s₁, s₂, s₃, . . . , s_{N}) (e.g., 510) using a multi-sensor system, e.g., multi-sensor system 140_{1-N}. In an embodiment, self-adjusting multi-sensor program 122 processes the set of training samples (e.g., s₁, s₂, s₃, . . . , s_{N}) (e.g., 510) by measuring one or more data features of the set of training samples (e.g., s₁, s₂, s₃, . . . , s_{N}), (e.g., 510) extracting a first set of data features (e.g., f₁, f₂, f₃, . . . , fₖ) (e.g., 515) from the set of training samples (e.g., s₁, s₂, s₃, . . . , s_{N}) (e.g., 510), and ranking one or more data features (e.g., 530) of the first set of data features according to a degree of importance of each data feature. In an embodiment, self-adjusting multi-sensor program 122 trains a first machine learning model (e.g., 520) on a first combination of the first set of data features (e.g., 515) using a supervised and/or self-supervised learning technique known to those skilled in the art. In an embodiment, self-adjusting multi-sensor program 122 determines whether the first machine learning model (e.g., 520) is accurate by performing a validation and/or testing of the first machine learning model (e.g., 520) on a set of data obtained from a measurement of samples (e.g., 510). Responsive to self-adjusting multi-sensor program 122 determining the first machine learning model (e.g., 520) is accurate, self-adjusting multi-sensor program 122 adds the first set of data features extracted (e.g., 515) and the first machine learning model (e.g., 520) to a pool of trained machine learning models (e.g., 535). Each machine learning model of the pool of trained machine learning models uses a different combination of the first set of data features to achieve a desired performance metric. In an embodiment, self-adjusting multi-sensor program 122 applies a feature selection. A feature selection is a selection of a set of sensor data to train a machine learning model. If a machine learning model satisfies the accuracy requirements, the machine learning model will be added to the pool of trained machine learning models. In an embodiment, self-adjusting multi-sensor program 122 applies a forward feature selection to produce a new set of data features. In an embodiment, self-adjusting multi-sensor program 122 applies a forward feature selection to find a minimal set of data features that allow the machine learning model to achieve the desired performance. In an embodiment, self-adjusting multi-sensor program 122 determines whether a new set of one or more data features exists by comparing a newly generated set of one or more data features from the feature selection (i.e., from step 330) to the sets of one or more data features that were previously used to train a set of machine learning models. Responsive to self-adjusting multi-sensor program 122 determining a new set of one or more data features exists, self-adjusting multi-sensor program 122 models a prediction (e.g., 525) with the new set of one or more data features. A prediction corresponds to an inference of a machine learning model.

In an embodiment, at time t₁>t₀ (e.g., 505_{N}), self-adjusting multi-sensor program 122 calibrates the multi-sensor system, e.g., multi-sensor system 140_{1-N}. In an embodiment, self-adjusting multi-sensor program 122 measures one or more calibration samples based on one or more signals generated by a transduction mechanism offered by one or more sensors of the multi-sensor system, e.g., multi-sensor system 140_{1-N}. In an embodiment, self-adjusting multi-sensor program 122 determines a set of transformation coefficients through a mathematical operation in a form of a statistical method. In another embodiment, self-adjusting multi-sensor program 122 determines a set of transformation coefficients through a mathematical operation in a form of a machine learning approach. In an embodiment, self-adjusting multi-sensor program 122 determines a set of transformation coefficients by comparing one or more sets of data features obtained from the one or more calibration samples measured at time t₁ (e.g., 545) with one or more sets of data features obtained from the one or more calibration samples measured at time t₀ (e.g., 555). In an embodiment, self-adjusting multi-sensor program 122 calibrates the multi-sensor system, e.g., multi-sensor system 140_{1-N} using a standardization technique known to those skilled in the art. The standardization technique known to those skilled in the art includes, but is not limited to, a Single Wavelength Standardization, a Direct Standardization, or a Piece-Wise Direct-Standardization. In an embodiment, self-adjusting multi-sensor program 122 calibrates the multi-sensor system, e.g., multi-sensor system 140_{1-N}, to assess a SOH of a sensor of the multi-sensor system, e.g., multi-sensor system 140_{1-N}. In an embodiment, self-adjusting multi-sensor program 122 calibrates the multi-sensor system, e.g., multi-sensor system 140_{1-N}, to determine a coefficient needed to transform, as best as possible, a feature matrix F(t₁) at time t₁ to match a feature F(t₀) at time t₀ for a known sample (i.e., a “calibration sample”). For a linear transformation, an equation F′(t₁)=TF(t₁)˜F(t₀) is used. F′(t₁) is defined as a feature extracted from a set of data recorded at time t₁ after a transformation and Tis defined as a matrix of a transformation coefficient. The number of calibration samples is significantly smaller than the number of training samples (e.g., by one order of magnitude), which makes calibration easier than training and therefore is strongly preferred for practical use of the multi-sensor system, e.g., multi-sensor system 140_{1-N}. In an embodiment, self-adjusting multi-sensor program 122 validates a calibration of the multi-sensor system, e.g., multi-sensor system 140_{1-N}, to assess an extent of deviation of each feature's actual value from each feature's expected value (i.e., a “feature degradation”). In an embodiment, self-adjusting multi-sensor program 122 measures a sub-set of training samples (i.e., a “validation sample” or “validation samples”) (e.g., 540) to provide a second set of data features. In an embodiment, self-adjusting multi-sensor program 122 compares the second set of data features to the first set of data features. In an embodiment, self-adjusting multi-sensor program 122 ranks the second set of data features (e.g., 545) according to a deviation of the second set of data features from the first set of data features (e.g., 555). In an embodiment, self-adjusting multi-sensor program 122 computes a ranked list of one or more critical features (e.g., 550). A critical feature is a feature that has a high ranking based on the feature having a high degree of degradation and high importance for the machine learning predictive model at the same time. A critical feature provides necessary information for the self-adjustment process. In an embodiment, self-adjusting multi-sensor program 122 recommends for use by the multi-sensor system, e.g., multi-sensor system 140_{1-N}, the trained machine learning model employing the ranked list of one or more critical features. In an embodiment, self-adjusting multi-sensor program 122 determines whether an alternative machine learning model is available by examining a list of machine learning models in the pool of trained machine learning models, ranked according to the result of the similarity search. Responsive to determining the alternative machine learning model (e.g., 560) is available (decision step 450, YES branch), then self-adjusting multi-sensor program 122 proceeds to step 455, selecting an alternative machine learning model (e.g., 560). In an embodiment, self-adjusting multi-sensor program 122 selects an alternative machine learning model. The alternative machine learning model is a machine learning model trained on the set of data features exhibiting the highest similarity score compared to the list of one or more critical features. In an embodiment, self-adjusting multi-sensor program 122 determines whether the prediction for the one or more validation samples is accurate by comparing the machine learning model prediction as obtained from an inference with a machine learning model with the ground truth property of the one or more validation samples. Responsive to determining the prediction for the one or more validation samples is accurate, then self-adjusting multi-sensor program 122 reports the results to the user.

FIG. 6 depicts a process flow diagram, generally designated 600, illustrating an interaction between different stages of self-adjusting multi-sensor program 122 used to determine a feature degradation, in accordance with an embodiment of the present invention. In an embodiment, self-adjusting multi-sensor program 122 selects two samples from a range of samples undergoing testing (e.g., samples 1-5) as calibration samples based on their ability to span a range (e.g., a minimum feature score and a maximum feature score). In an embodiment, self-adjusting multi-sensor program 122 selects one sample from the range of samples undergoing testing (e.g., samples 1-5) as a validation sample. The validation sample may be a sample with a feature score closest to a median. The validation sample is preferably not one of the two calibration samples. In an embodiment, self-adjusting multi-sensor program 122 measures the two calibration samples during an inference to determine one or more standardization parameters, also called transformation coefficients. Standardization is further applied to the measurement of the validation sample. The distance of the standardized feature score of the validation sample to its nominal score during training may be used to measure feature degradation. It is evident to those skilled in the art that the example described in FIG. 6 may easily be extended to a number of calibration samples and validation samples within a scope of the present invention.

FIG. 7 depicts a block diagram, generally designated 700, of components of server 120 within distributed data processing environment 100 of FIG. 1, in accordance with an embodiment of the present invention. It should be appreciated that FIG. 7 provides only an illustration of one implementation and does not imply any limitations with regard to the environments in which different embodiments can be implemented. Many modifications to the depicted environment can be made.

Computing environment 700 contains an example of an environment for the execution of at least some of the computer code involved in performing the inventive methods, such as self-adjusting multi-sensor program 122. In addition to self-adjusting multi-sensor program 122, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and self-adjusting multi-sensor program 122, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in self-adjusting multi-sensor program 122 in persistent storage 713.

Communication fabric 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface type operating systems that employ a kernel. The code included in self-adjusting multi-sensor program 122 typically includes at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701) and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
training, by one or more processors, a first set of machine learning models on a first combination of a first set of data features;
measuring, by the one or more processors, a sub-set of a set of training samples to provide a second set of data features;
combining, by the one or more processors, the first set of data features and the second set of data features to obtain a third set of data features, wherein the third set of data features is a preferred set of data features; and
recommending, by the one or more processors, for use by a multi-sensor system, a first machine learning model employing the preferred set of data features.

2. The computer-implemented method of claim 1, further comprising:
prior to training the first set of machine learning models on the first combination of the first set of data features, gathering, by the one or more processors, the set of training samples using the multi-sensor system at time t₀, wherein said gathering step further comprises:
measuring, by the one or more processors, one or more data features of the set of training samples;
ranking, by the one or more processors, each data feature of the one or more data features according to a degree of importance of each data feature; and
extracting, by the one or more processors, the first set of data features.

3. The computer-implemented method of claim 1, further comprising:
subsequent to training the first set of machine learning models on the first combination of the first set of data features, creating, by the one or more processors, a pool of trained machine learning models, wherein the pool of trained machine learning models includes one or more machine learning models that have achieved a desired performance metric, and wherein each machine learning model uses a different combination of the first set of data features to achieve the desired performance metric.

4. The computer-implemented method of claim 3, further comprising:
subsequent to creating the pool of trained machine learning models, calibrating, by the one or more processors, the multi-sensor system at time t₁>t₀ using a standardization technique to assess a state of health of a sensor of the multi-sensor system; and
validating, by the one or more processors, a calibration of the multi-sensor system to assess a degree of accuracy of a prediction of a machine learning model and to assess an extent of deviation of an actual value of each feature from an expected value of each feature.

5. The computer-implemented method of claim 4, wherein the standardization technique is at least one of a single wavelength standardization technique, a direct standardization technique, and a piece-wise direct-standardization technique.

6. The computer-implemented method of claim 1, wherein measuring the sub-set of training samples to provide the second set of data features further comprises:
comparing, by the one or more processors, the second set of data features to the first set of data features;
ranking, by the one or more processors, each data feature of the second set of data features according to a deviation of the second set of data features from the first set of data features; and
extracting, by the one or more processors, the second set of data features.

7. The computer-implemented method of claim 4, further comprising:
determining, by the one or more processors, a performance of the first machine learning model is below a pre-set accuracy threshold by performing an inference on the first machine learning model using one or more validation samples; and
self-adjusting, by the one or more processors, the first machine learning model to fulfill the desired performance metric.

8. The computer-implemented method of claim 7, wherein self-adjusting the first machine learning model to fulfill the desired performance metric further comprises:
selecting, by the one or more processors, a second machine learning model from the pool of trained machine learning models based a selection criterion based on a combined ranking of features, wherein the combined ranking of features is derived from a degree of importance of a feature and a degradation of the feature.

9. A computer program product comprising:
one or more computer readable storage media and program instructions stored on the one or more computer readable storage media, the program instructions comprising:
program instructions to train a first set of machine learning models on a first combination of a first set of data features;
program instructions to measure a sub-set of a set of training samples to provide a second set of data features;
program instructions to combine the first set of data features and the second set of data features to obtain a third set of data features, wherein the third set of data features is a preferred set of data features; and
program instructions to recommend, for use by a multi-sensor system, a first machine learning model employing the preferred set of data features.

10. The computer program product of claim 9, further comprising:
prior to training the first set of machine learning models on the first combination of the first set of data features, program instructions to gather the set of training samples using the multi-sensor system at time t₀, wherein said gathering step further comprises:
program instructions to measure one or more data features of the set of training samples;
program instructions to rank each data feature of the one or more data features according to a degree of importance of each data feature; and
program instructions to extract the first set of data features.

11. The computer program product of claim 9, further comprising:
subsequent to training the first set of machine learning models on the first combination of the first set of data features, program instructions to create a pool of trained machine learning models, wherein the pool of trained machine learning models includes one or more machine learning models that have achieved a desired performance metric, and wherein each machine learning model uses a different combination of the first set of data features to achieve the desired performance metric.

12. The computer program product of claim 11, further comprising:
subsequent to creating the pool of trained machine learning models, program instructions to calibrate the multi-sensor system at time t₁>t₀ using a standardization technique to assess a state of health of a sensor of the multi-sensor system; and
program instructions to validate a calibration of the multi-sensor system to assess a degree of accuracy of a prediction of a machine learning model and to assess an extent of deviation of an actual value of each feature from an expected value of each feature.

13. The computer program product of claim 12, further comprising:
program instructions to determine a performance of the first machine learning model is below a pre-set accuracy threshold by performing an inference on the first machine learning model using one or more validation samples; and
program instructions to self-adjust the first machine learning model to fulfill the desired performance metric.

14. The computer program product of claim 13, wherein self-adjusting the first machine learning model to fulfill the desired performance metric further comprises:
program instructions to select a second machine learning model from the pool of trained machine learning models based a selection criterion based on a combined ranking of features, wherein the combined ranking of features is derived from a degree of importance of a feature and a degradation of the feature.

15. A computer system comprising:
one or more computer processors;
one or more computer readable storage media;
program instructions collectively stored on the one or more computer readable storage media for execution by at least one of the one or more computer processors, the stored program instructions comprising:
program instructions to train a first set of machine learning models on a first combination of a first set of data features;
program instructions to measure a sub-set of a set of training samples to provide a second set of data features;
program instructions to combine the first set of data features and the second set of data features to obtain a third set of data features, wherein the third set of data features is a preferred set of data features; and
program instructions to recommend, for use by a multi-sensor system, a first machine learning model employing the preferred set of data features.

16. The computer system of claim 15, further comprising:
prior to training the first set of machine learning models on the first combination of the first set of data features, program instructions to gather the set of training samples using the multi-sensor system at time t₀, wherein said gathering step further comprises:
program instructions to measure one or more data features of the set of training samples;
program instructions to rank each data feature of the one or more data features according to a degree of importance of each data feature; and
program instructions to extract the first set of data features.

17. The computer system of claim 15, further comprising:
subsequent to training the first set of machine learning models on the first combination of the first set of data features, program instructions to create a pool of trained machine learning models, wherein the pool of trained machine learning models includes one or more machine learning models that have achieved a desired performance metric, and wherein each machine learning model uses a different combination of the first set of data features to achieve the desired performance metric.

18. The computer system of claim 17, further comprising:
subsequent to creating the pool of trained machine learning models, program instructions to calibrate the multi-sensor system at time t₁>t₀ using a standardization technique to assess a state of health of a sensor of the multi-sensor system; and
program instructions to validate a calibration of the multi-sensor system to assess a degree of accuracy of a prediction of a machine learning model and to assess an extent of deviation of an actual value of each feature from an expected value of each feature.

19. The computer system of claim 18, further comprising:
program instructions to determine a performance of the first machine learning model is below a pre-set accuracy threshold by performing an inference on the first machine learning model using one or more validation samples; and
program instructions to self-adjust the first machine learning model to fulfill the desired performance metric.

20. The computer system of claim 19, wherein self-adjusting the first machine learning model to fulfill the desired performance metric further comprises:
program instructions to select a second machine learning model from the pool of trained machine learning models based a selection criterion based on a combined ranking of features, wherein the combined ranking of features is derived from a degree of importance of a feature and a degradation of the feature.
